(19) United States
(12) Patent Application Publication
(10) Pub. No.: US 2024/0418233 A1
(43) Pub. Date: Dec. 19, 2024

(54) SEAL DEVICE FOR HYDRAULIC APPARATUS AND SHOCK ABSORBER

(71) Applicant: KYB Corporation, Tokyo (JP)

(72) Inventors: Masaki KOYAMA, Tokyo (JP); Kiyoshi KANI, Tokyo (JP); Takeshi YASUI, Tokyo (JP)

(73) Assignee: KYB Corporation, Tokyo (JP)

(21) Appl. No.: 18/704,088

(22) PCT Filed: Nov. 1, 2022
(86) PCT No.: PCT/JP2022/040865

§ 371 Date: Apr. 24, 2024

(30) Foreign Application Priority Data
Nov. 25, 2021 (JP) 2021-190897

(51) Int. Cl. F16F 9/36; F16F 9/06; F16F 9/19; F16F 9/348

(52) U.S. Cl. CPC F16F 9/368; F16F 9/19; F16F 9/348; F16F 9/061

(57) ABSTRACT

A seal device for a hydraulic apparatus according to the present invention includes an annular main piston split body (outer member), a sub piston split body (inner member) inserted into inside the main piston split body (outer member), and a seal ring accommodated in an annular groove provided in the outer circumference of the sub piston split body (inner member) and abutting on the other of the main piston split body (outer member) to prevent a liquid from passing through a gap between the main piston split body (outer member) and the sub piston split body (inner member), in which the seal ring has a self-lubricating property and has a cylindrical surface centered on an axis on an inner peripheral surface (bottom facing surface) facing a bottom of the annular groove.

### TECHNICAL FIELD

The present invention relates to a seal device for a hydraulic apparatus and a shock absorber.

### BACKGROUND ART

A seal device for a hydraulic apparatus is employed in a hydraulic apparatus such as a shock absorber interposed between a vehicle body and a wheel and configured to exert a damping force to suppress vibrations of the vehicle body and the wheel and a cylinder device configured to drive a boom or an arm of a construction machine.

As disclosed in JP 2017-96453 A, a seal device applied to a shock absorber includes a seal ring which seals a gap between a main piston split body and a sub piston split body in a piston including the main piston split body and the sub piston split body held by a nut on the outer circumference of a rod.

The piston is provided with a passage for communicating an extension side chamber and a compression side chamber inside a cylinder partitioned by the piston. Furthermore, two leaf valves for opening and closing the passage are attached to the corresponding main piston split body and the sub piston split body.

The main piston split body has a disk shape, and is fitted into a tubular portion protruding from the sub piston split body to close the tubular portion. The seal ring is fitted into a tubular portion protruding from the sub piston split body and accommodated in an annular groove disposed circumferentially along the outer circumference of the main piston split body, and the seal ring adheres closely to the inner circumference of the tubular portion to seal the gap between the main piston split body and the sub piston split body.

According to the seal device with this configuration, the seal ring prevents hydraulic oil from bypassing the valves and from passing through the gap between the main piston split body and the sub piston split body, thereby enabling the shock absorber to exert a damping force as designed.

### CITATION LIST

### Patent Literature

Patent Literature 1: JP 2017-96453 A

### SUMMARY OF INVENTION

### Technical Problem

As described above, in order for a seal device to seal a gap between a main piston split body and a sub piston split body, an annular groove needs to be disposed in the outer circumference of a portion fitted into a tubular portion of the sub piston split body of the main piston split body, and the main piston split body needs to be inserted into the tubular portion after a seal ring is accommodated in the annular groove.

In order to prevent the seal ring from falling off the annular groove, it is profoundly important that the seal ring is designed to have an inside diameter smaller than an outside diameter of a part in the main piston split body which is fitted into the tubular portion and that the seal ring is enlarged in diameter when being placed in the annular groove.

In order for the seal ring to appropriately seal the gap between the main piston split body and the sub piston split body, the seal ring is to be strongly pressed against the tubular portion of the sub piston split body and designed to have an outside diameter larger than an inside diameter of the tubular portion, so that the seal ring is inserted into the tubular portion in a compressed state. Therefore, the insertion of the main piston split body with the seal ring placed therein into the tubular portion of the sub piston split body accompanies the compression of the seal ring.

The seal ring is formed, for example, by vulcanized rubber. However, a hard material is occasionally employed from a durability perspective as well as perspectives of preventing the seal ring from falling out of the annular groove and ensuring a pressing force against the tubular portion, and the use of a hard material imposes a heavy burden on an operator when placing the seal ring in the annular groove and fitting the main piston split body into the tubular portion.

In order to reduce the burden on an operator and to enhance ease of operation, there is an attempt to reduce a frictional force created between a seal ring and a main piston split body or a tubular portion by providing the seal ring has a self-lubricating property or by performing surface treatment on the seal ring.

However, reducing a frictional force created between a seal ring and a main piston split body or a tubular portion by such treatment on the seal ring promotes axial displacement of the seal ring within an annular groove, and even low pressure from an extension side chamber or a compression side chamber may displace the seal ring within the annular groove.

For this reason, when a shock absorber is activated at an extremely low speed, the seal ring moves within the annular groove and causes a change in passage capacity corresponding to a distance through which the seal ring moves, thereby producing an effect as in a condition where hydraulic oil in an amount corresponding to the change in capacity apparently bypasses leaf valves and passes through a gap between the main piston split body and sub piston split body.

Such an effect becomes the cause of a reduction in an amount of hydraulic oil passing through the leaf valves when the shock absorber extends or contracts at an extremely low speed, and the shock absorber becomes less able to exert a damping force as intended, which causes a time delay in generating a damping force.

Even in a case where the outer circumference of a piston is provided with an annular groove and a seal ring slidably in contact with a cylinder along which the piston slides is accommodated in the annular groove, displacement of the seal ring produces an effect as in a condition where hydraulic oil apparently bypasses valves and passes through a gap between the cylinder and the piston. In a case where a gas chamber is disposed in the cylinder by a free piston and a seal ring slidably in contact with the cylinder is accommodated in the outer circumference of the free piston in the disposed annular groove, displacement of the seal ring within the annular groove reduces an amount of hydraulic oil passing through the valves. Even in a cylinder device instead of a shock absorber, when hydraulic oil is supplied to a cylinder, displacement of a seal ring apparently hinders the supply of hydraulic oil into the cylinder corresponding to a distance that the seal ring moves, thereby causing a time delay in generating thrust in the cylinder device.

As described above, in a seal device in a hydraulic apparatus such as a shock absorber and a cylinder device, reducing a frictional force of a seal ring in order to enhance ease of placing the seal ring and ease of assembling a hydraulic apparatus creates a disadvantage of time delay in generating a damping force or thrust in the hydraulic apparatus.

An object of the invention is to provide a seal device capable of enhancing ease of assembly while preventing a time delay in generating a damping force or thrust in a hydraulic apparatus and to provide a shock absorber capable of enhancing ease of assembly while preventing a time delay in generating a damping force.

### Solution to Problem

In order to solve the above problems, a seal device for a hydraulic apparatus of the present invention includes an outer member having an annular shape, an inner member inserted into the outer member, and a seal ring accommodated in an annular groove disposed in one of the outer member and the inner member and abutting on the other of the outer member and the inner member to prevent a liquid from passing through a gap between the outer member and the inner member, in which the seal ring has a self-lubricating property and has a cylindrical surface centered on the axis on a bottom facing surface facing the bottom of the annular groove.

According to the seal device configured as described above, since the seal ring has the self-lubricating property, the assemblability to the annular groove can be improved, and since the bottom facing surface of the seal ring has the cylindrical surface, even if the seal ring has the self-lubricating property, a large frictional force can be generated between the seal ring and the bottom of the annular groove to regulate the axial movement of the seal ring in the annular groove.

### BRIEF DESCRIPTION OF DRAWINGS

FIG. 1 is a longitudinal sectional view of a shock absorber to which a seal device for a hydraulic apparatus according to an embodiment is applied.

FIG. 2 is an enlarged sectional view of a piston in the shock absorber to which the seal device for the hydraulic apparatus according to the embodiment is applied.

FIG. 3 is an enlarged sectional view of a part of the piston in the shock absorber to which the seal device for the hydraulic apparatus according to the embodiment is applied.

FIG. 4(a) is a cross-sectional view of a seal ring of the seal device for the hydraulic apparatus according to the embodiment. FIG. 4(b) is a plan view of the seal ring of the seal device for the hydraulic apparatus according to the embodiment.

FIG. 5 is a partially enlarged cross-sectional view of a seal ring in the seal device for the hydraulic apparatus according to a first modification example of the embodiment.

FIG. 6(a) is a partially enlarged longitudinal cross-sectional view of an inner member in the seal device for the hydraulic apparatus according to a second modification example of the embodiment. FIG. 6(b) is a partially enlarged longitudinal cross-sectional view of an inner member in the seal device for the hydraulic apparatus according to a third modification example of the embodiment. FIG. 6(c) is a partially enlarged longitudinal cross-sectional view of an inner member in the seal device for the hydraulic apparatus according to a fourth modification example of the embodiment.

FIG. 7 is a longitudinal cross-sectional view of a shock absorber to which a seal device according to a fifth modification example of the embodiment is applied.

### DESCRIPTION OF EMBODIMENTS

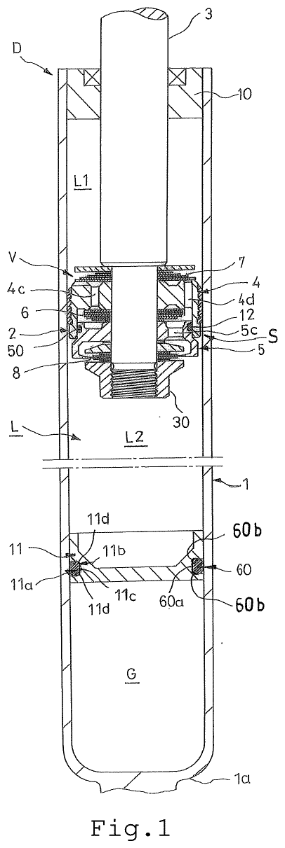

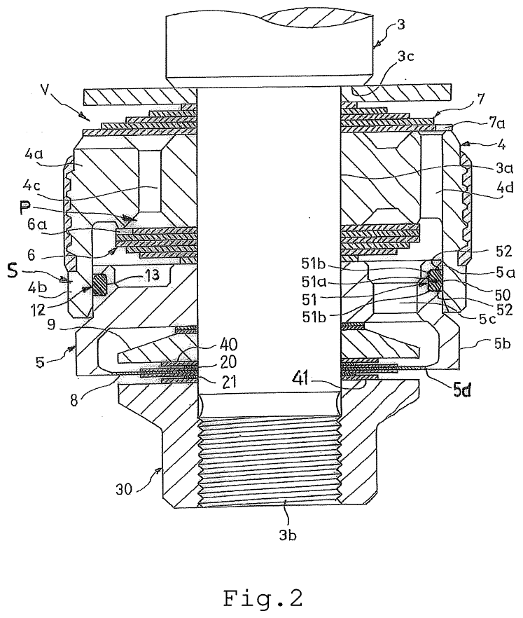

Hereinafter, the present invention will be described based on an embodiment illustrated in the drawings. As illustrated in FIGS. 1 and 2, a seal device S for a hydraulic apparatus according to an embodiment is applied to a shock absorber D as a hydraulic apparatus. The shock absorber D is provided with a cylinder 1, a piston 2 inserted into the cylinder 1 to be axially movable and including a passage P which partitions the interior of the cylinder 1 into two hydraulic chambers, that is, an extension side chamber L1 and a compression side chamber L2, and communicates the extension side chamber L1 and the compression side chamber L2, a rod 3 inserted into the cylinder 1 to be axially movable, a valve V configured to open and close the passage P, and a seal device S. The shock absorber D according to the present embodiment is interposed between a vehicle body and an axle in a vehicle (not illustrated) in order to suppress vibrations of the vehicle body and a wheel. Note that an object where the shock absorber D provided with the seal device S according to the invention is installed is not limited to a vehicle and may be changed in an appropriate manner. The shock absorber D illustrated in FIG. 1 may be turned upside down depending on the object.

Next, specific structures of the seal device S and the shock absorber D provided with the seal device S will be described. As illustrated in FIG. 1, the cylinder 1 has a bottomed tubular shape, including an annular rod guide 10 attached to the inner circumference of an upper end of the cylinder 1, and the rod 3 is slidably inserted into this rod guide 10. This configuration makes the interior of the cylinder 1 a sealed space.

The rod 3 has an upper end provided with a bracket (not illustrated), and the rod 3 is connected to one of the vehicle body and the axle through the bracket. The cylinder 1 has a bottom 1a also provided with a bracket (not illustrated), and the cylinder 1 is connected to the other of the vehicle body and the axle through the bracket.

The shock absorber D is interposed between the vehicle body and the axle in this manner. When the vehicle travels on a bumpy road, for example, and the wheel vibrates up and down relative to the vehicle body, the piston 2 moves up and down (axially) inside the cylinder 1 along with the rod 3 moving in and out of the cylinder 1 to extend and contract the shock absorber D.

Furthermore, a free piston 11 is slidably inserted into the opposite side of the rod 3 as viewed from the piston 2 inside the cylinder 1. The free piston 11 partitions the interior of the cylinder 1 into a liquid chamber L filled with a liquid such as hydraulic oil and a gas chamber G filled with a gas. In addition, the piston 2 inserted into the cylinder 1 to be axially movable partitions the liquid chamber L into two hydraulic chambers, that is, the extension side chamber L1 illustrated on the upper side of FIG. 1 and the compression side chamber L2 illustrated on the lower side of FIG. 1. The gas chamber G is filled with a compressed gas. Note that the shock absorber D may use not only hydraulic oil but also another liquid such as water or an aqueous solution. A gas filled in the gas chamber G is preferably an inert gas such as nitrogen gas but may be another gas.

As illustrated in FIGS. 1 and 2, the rod 3 includes a small-diameter portion 3a, a screw portion 3b, and a stepped portion 3c and is inserted into the cylinder 1 through the rod guide 10 to be axially movable. The small-diameter portion 3a is formed by reducing an outside diameter of a lower part of the rod 3, and the piston 2 is attached to the outer circumference of the small-diameter portion 3a. The screw portion 3b is formed on the outer circumference of the tip of the small-diameter portion 3a. The stepped portion 3c is formed at the boundary between the rod 3 and the small-diameter portion 3a.

When the shock absorber D extends, the rod 3 comes out of the cylinder 1 and the cylinder capacity increases to an extent corresponding to a volume of the rod 3 pulled out of the cylinder 1, which allows the free piston 11 to move upward inside the cylinder 1, whereby the gas chamber G is expanded. In contrast, when the shock absorber D contracts, the rod 3 goes into the cylinder 1 and the cylinder capacity decreases to an extent corresponding to a volume of the rod 3 entering the cylinder 1, which allows the free piston 11 to move downward inside the cylinder 1, whereby the gas chamber G is contracted. As described above, the shock absorber D as a hydraulic apparatus according to this embodiment is a monotube shock absorber with a single rod, and is configured to expand and contract the gas chamber G by motions of the free piston 11 at the time of extension and contraction to compensate for the volume of the rod 3 moving in and out of the cylinder 1. Note that the liquid chamber L and the gas chamber G may be partitioned by a bladder or a bellows instead of the free piston 11.

Instead of forming the gas chamber G by the free piston 11, an outer shell may be disposed on the outer circumference of the cylinder 1 to form a reservoir filled with a liquid and a gas between the cylinder 1 and the outer shell, and the volume of the rod 3 moving in and out of the cylinder 1 may be compensated for by the reservoir. In addition to the outer shell disposed on the outer circumference of the cylinder 1, a tank may be employed independently of the cylinder 1 forming the reservoir. Alternatively, the shock absorber D may be a double-rod shock absorber provided with a rod on both sides of the piston.

The piston 2 includes a main piston split body 4 as an outer member and a sub piston split body 5 as an inner member held by a nut 30 on the outer circumference of the rod 3. The main piston split body 4 includes main valve bodies 6 and 7 stacked thereon, and the sub piston split body 5 includes a sub valve body 8 attached thereto. The main valve bodies 6 and 7 and the sub valve body 8 constitute the valve V.

As illustrated in FIG. 2, the main piston split body 4 constitutes the outer member of the seal device S, including an annular main body portion 4a and a tubular portion 4b protruding downward from an outer circumferential portion of a lower end of this main body portion 4a. The main body portion 4a is provided with an extension side passage 4c and a compression side passage 4d which open on the side closer to the inner circumference of the tubular portion 4b and are configured to axially penetrate the main body portion 4a. Furthermore, a lower part of the main body portion 4a (closer to the compression side chamber L2) has the extension side main valve body 6 for opening and closing the extension side passage 4c stacked thereon, and an upper part of the main body portion 4a (closer to the extension side chamber L1) has the compression side main valve body 7 for opening and closing the compression side passage 4d stacked thereon.

The extension side and compression side main valve bodies 6 and 7 in the shock absorber D according to this embodiment are stacked leaf valves in which a plurality of elastically deformable leaf valves is stacked. The number of leaf valves in the main valve bodies 6 and 7 is optionally changeable depending on a desired damping force.

When the shock absorber D extends while the piston speed is in the medium- or high-speed range, the extension side main valve body 6 opens and offers resistance to a liquid flowing through the extension side passage 4c from the extension side chamber L1 to the compression side chamber L2. In contrast, when the shock absorber D contracts while the piston speed is in the medium- or high-speed range, the compression side main valve body 7 opens and offers resistance to a liquid flowing through the compression side passage 4d from the compression side chamber L2 to the extension side chamber L1.

Among the plurality of leaf valves included in the extension side and compression side main valve bodies 6 and 7, the leaf valves closest to the main piston split body 4 have outer circumferential portions respectively provided with cutouts 6a or 7a. When the piston speed is in the low-speed range and the extension side and compression side main valve bodies 6 and 7 are closed, a liquid passes through orifices formed by the cutouts 6a and 7a and moves back and forth between the extension side chamber L1 and the compression side chamber L2. The orifices (cutouts 6a and 7a) offer resistance to a flow of this liquid.

The orifices formed by the cutouts 6a and 7a allow a bidirectional flow of the liquid. One of the cutouts 6a and 7a disposed in the extension side and compression side main valve bodies 6 and 7 may be omitted. A method for forming an orifice may be changed in an appropriate manner. For example, an orifice may be formed by punching a valve seat where the extension side main valve body 6 or the compression side main valve body 7 is separated or seated. Alternatively, a choke may be used as a substitute for the orifice. Furthermore, the main valve bodies 6 and 7 which are attached to the main piston split body 4 and cause the shock absorber D to generate a damping force in the medium- or high-speed range are not necessarily the stacked leaf valves and may be poppet valves.

As illustrated in FIG. 2, the sub piston split body 5 constitutes the inner member, including a fitting portion 5a, a casing portion 5b, a communication passage 5c, and an annular groove 50. The fitting portion 5a has an annular shape, being fitted into the inner circumference of the tubular portion 4b of the main piston split body 4. The casing portion 5b has a tubular shape, protruding downward from an outer circumferential portion of a lower end of the fitting portion 5a. The communication passage 5c axially penetrates the fitting portion 5a, being opened on the side closer to the inner circumference of the casing portion 5b. The annular groove 50 is disposed circumferentially along the outer circumference of the fitting portion 5a. The annular groove 50 on the outer circumference of the fitting portion 5a houses a seal ring 12 which abuts on the inner circumference of the tubular portion 4b of the main piston split body 4 as the outer member and seals a gap between the main piston split body 4 and the sub piston split body 5.

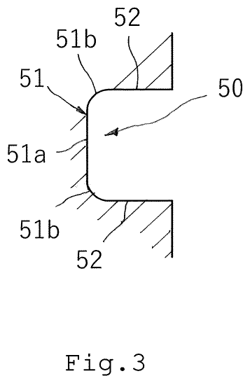

As illustrated in FIG. 3, the annular groove 50 in the sub piston split body 5 is disposed circumferentially along the entire outer circumference of the fitting portion 5a and is formed into a recessed groove which is surrounded by a bottom 51 and a pair of side walls 52 and 52 stretching axially in parallel from both ends of the bottom 51 to face each other.

In addition, as illustrated in FIG. 3, the bottom 51 includes a cylindrical bottom surface 51a having the deepest groove depth at the center in FIG. 3, and curved surfaces 51b and 51b that are vertically continuous on both sides of the bottom surface 51a in the axial direction and gradually decrease in depth toward the side wall 52, thereby forming one recess as a whole.

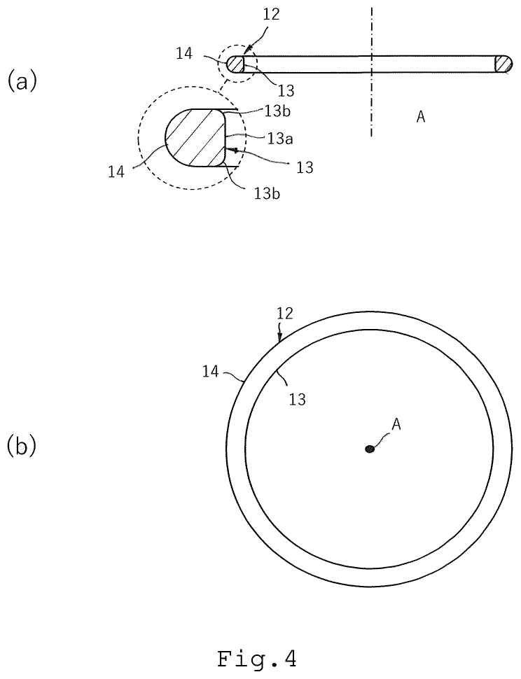

The annular groove 50 having this configuration houses the seal ring 12 composed of an O-ring. The seal ring 12 is formed of rubber or the like mixed with a lubricant and has a self-lubricating property. As illustrated in FIGS. 4(a) and 4(b), the seal ring 12 includes a cylindrical surface 13a centered on an axis A of the seal ring 12 at the axial center of an inner peripheral surface 13, which is a bottom facing surface facing a bottom 51 of the annular groove 50, and curved surfaces 13b and 13b that move away from the bottom 51 toward the axial end on both axial sides of the cylindrical surface 13a of the inner peripheral surface 13. The inner diameter of the seal ring 12 is smaller than the minimum outer diameter of the bottom 51 of the annular groove 50. Further, a cross-sectional shape of the seal surface 14 of the seal ring 12 on the outer peripheral side facing the tubular portion 4b of the main piston split body 4 is a circular arc shape.

Furthermore, the seal ring 12 is subjected to surface treatment to have a smooth surface, which reduces a frictional force between the seal ring 12 and other components. Rubber having self-lubricating properties is obtained by mixing a lubricant into base material rubber as described above. As the base material rubber, any rubber used for sealing may be employed. Examples of such rubber include fluororubber, ethylene-propylene-diene terpolymer rubber, acrylic rubber, acrylonitrile-butadiene rubber, and hydrogenated acrylonitrile-butadiene rubber. With regard to the lubricant mixed in the base material rubber, any material bled from the base material rubber and having lubricating properties may be employed. Examples of the material include silicone oil, modified silicone oil, and other oils, paraffin wax and other waxes and also include fatty acids, fatty acid salts, and fatty acid amides.

A filling rate of a general seal ring with respect to the annular groove is in a range of 60% to 80%, but a filling rate (calculated by multiplying a value obtained by dividing the volume of the seal ring 12 by the volume of the annular groove 50, by 100, or calculated by multiplying a value obtained by dividing the cross-sectional area of the seal ring 12 by the cross-sectional area of the annular groove 50, by 100) of the seal ring 12 with respect to the annular groove 50 is set to 80% or more and 90% or less. In calculation of the filling rate, in a case where there is a non-negligible gap between the fitting portion 5a of the sub piston split body 5 provided with the annular groove 50 and the tubular portion 4b of the main piston split body 4 with which the seal ring 12 accommodated in the annular groove 50 is in close contact, a value obtained by dividing the volume of the seal ring 12 by the total volume of the volume of the annular groove 50 and the volume of the portion facing the annular groove 50 in the radial direction in the gap is multiplied by 100 to obtain the filling rate.

In order to place the seal ring 12 configured as described above in the annular groove 50, the seal ring 12 is fitted to the outer periphery of the fitting portion 5a of the sub piston split body 5 before being assembled to the main piston split body 4 while expanding the diameter from the upper end side in FIG. 2, and moved downward to a position where the annular groove 50 exists. When the seal ring 12 faces the annular groove 50, the diameter of the seal ring is reduced, and the seal ring enters and is accommodated in the annular groove 50. Since the seal ring 12 has a self-lubricating property as described above, the frictional force between the seal ring 12 enlarged in diameter at the outer periphery of the fitting portion 5a and the fitting portion 5a in the work of assembling the seal ring into the annular groove 50 is reduced as compared with a seal ring not having self-lubricating property, so that the assemblability of the seal ring 12 is improved.

Since the seal ring 12 accommodated in the annular groove 50 as described above has an inner diameter smaller than the minimum outer diameter of the bottom 51 of the annular groove 50, the seal ring is accommodated in the annular groove 50 in an expanded state, and the cylindrical surface 13a is brought into close contact with the bottom surface 51a of the bottom 51 in order to contract by self-restoring force. Further, in the seal device S of the present embodiment, the curved surfaces 51b and 51b are provided on both axial sides of the bottom surface 51a of the bottom 51 of the annular groove 50, and the seal ring 12 also includes the curved surfaces 13b and 13b on both axial sides of the cylindrical surface 13a of the inner peripheral surface 13. When the seal ring 12 is accommodated in the annular groove 50, not only the cylindrical surface 13a comes into close contact with the bottom surface 51a, but also the curved surface 13b and the curved surface 51b come into close contact with each other.

When the fitting portion 5a of the sub piston split body 5 is inserted into the tubular portion 4b of the main piston split body 4, the seal ring 12 is compressed by the tubular portion 4b and decreases in outside diameter. Due to its self-restoring force, the seal ring 12 presses the inner peripheral surface of the tubular portion 4b and adheres closely to the inner circumference of the tubular portion 4b. Therefore, the seal ring 12 seals between the main piston split body 4 and the sub piston split body 5 by bringing the cylindrical surface 13a into close contact with the bottom 51 of the annular groove 50 to tighten the bottom 51 and strongly bringing the seal surface 14 on the outer peripheral side into close contact with the tubular portion 4b. Further, in the seal device S of the present embodiment, since the seal ring 12 includes the flat cylindrical surface 13a on the inner peripheral surface 13 which is the bottom facing surface facing the bottom 51 of the annular groove 50, the entire cylindrical surface 13a of the seal ring 12 is in contact with the bottom 51, and thus the area where the inner peripheral surface 13 of the seal ring 12 is in contact with the bottom 51 is larger than the area where the seal ring having a simple circular annular cross section is in contact with the bottom 51 when the seal ring is accommodated in the annular groove 50. In addition, since the seal ring 12 includes the flat cylindrical surface 13a on the inner peripheral surface 13 which is a bottom facing surface facing the bottom 51 of the annular groove 50, a relatively uniform surface pressure acts on the cylindrical surface 13a in contact with the bottom 51 by the self-restoring force. On the other hand, in a case where the annular seal ring having a simple circular cross section is accommodated in the annular groove 50, a relatively large surface pressure acts on the axial center of the portion where the seal ring comes into contact with the bottom 51, but the surface pressure of the portion deviating from the center becomes low.

Therefore, in the seal device S of the present embodiment, a large frictional force is generated between the inner peripheral surface 13 of the seal ring 12 and the bottom 51 of the annular groove 50, and the movement in the axial direction is restricted in the annular groove 50. For this reason, even when pressure acts on the seal ring 12 from an upper part or lower part of FIG. 3, the position of the seal ring 12 is determined in the midsection of the annular groove 50, and the seal ring 12 is prevented from deviating in the axial direction, or up-down direction. Since the inner peripheral surface 13 of the seal ring 12 is provided with the curved surfaces 13b and 13b, and the bottom 51 is also provided with the curved surfaces 51b and 51b, in addition to the cylindrical surface 13a of the seal ring 12 coming into close contact with the bottom surface 51a, the curved surfaces 13b and 13b also come into close contact with the curved surfaces 51b and 51b at the bottom 51 of the annular groove 50. Therefore, since the entire inner peripheral surface 13 of the seal ring 12 is in close contact with the bottom 51 and a large frictional force is generated between the seal ring 12 and the bottom 51, in the seal device S of the present embodiment, the positional displacement of the seal ring 12 in the axial direction is further effectively suppressed. Note that the cross-sectional shape of the annular groove 50 may be rectangular without providing the curved surfaces 51b and 51b on the bottom 51.

Furthermore, in the present embodiment, since the filling rate of the seal ring 12 with respect to the annular groove 50 is 80% or more and 90% or less, which is higher than the filling rate of a general seal ring, the seal ring 12 is less likely to move in the annular groove 50, and thus the positional displacement of the seal ring 12 in the axial direction is further effectively suppressed.

In addition, the casing portion 5b in the sub piston split body 5 has the tip provided with an annular opposing portion 5d protruding radially inward from the inner circumference of the casing portion 5b. Furthermore, two stopper members 9 and 40 having different outside diameters are accommodated in the casing portion 5b. Further, the sub valve body 8 and the stopper member 41 are laminated on the lower side of the stopper member 40 in FIG. 2.

As illustrated in FIG. 2, the sub valve body 8 according to this embodiment includes three stacked leaf valves. The middle leaf valve is larger than the upper and lower leaf valves in outside diameter. A spacer 20 is interposed between the upper leaf valve and the stopper member 40 immediately above the leaf valve, and a spacer 21 is interposed between the lower leaf valve and the stopper member 41 immediately below the leaf valve.

Following the main valve body 7, the main piston split body 4, the main valve body 6, and the sub piston split body 5, the stopper members 9 and 40, the spacer 20, the sub valve body 8, the spacer 21, and the stopper member 41 are attached to the outer circumference of the small-diameter portion 3a of the rod 3 in order and are fixed to the small-diameter portion 3a of the rod 3 together with the main valve body 7, the main piston split body 4, the main valve body 6, and the sub piston split body 5 by being sandwiched between the stepped portion 3c and the nut 30 screwed into the screw portion 3b. The fitting portion 5a of the sub piston split body 5 is inserted into the tubular portion 4b of the main piston split body 4, and the extension side passage 4c and the compression side passage 4d abutting on the extension side chamber L1 are communicated with the compression side chamber L2 through the communication passage 5c and the casing portion 5b. With this configuration, the passage P disposed in the piston 2 is formed inside the extension side passage 4c, the compression side passage 4d, the communication passage 5c, and the casing portion 5b. Since the seal ring 12 within the annular groove 50 adheres closely to the inner circumference of the tubular portion 4b and seals the gap between the tubular portion 4b of the main piston split body 4 and the fitting portion 5a of the sub piston split body 5, the seal device S prevents a liquid from passing through the gap between tubular portion 4b and the fitting portion 5a except for the passage P.

Each of the spacers 20 and 21 is an annular plate having an outside diameter smaller than that of each leaf valve included in the sub valve body 8. The sub valve body 8 is fixed to the sub piston split body 5 while having the inner circumference sandwiched by the spacers 20 and 21. Parts of the sub valve body 8 on the outer side of the spacers 20 and 21 move up and down (axially) using abutting portions between the spacers 20, 21 and the sub valve body 8 as fulcrums.

As described above, in this embodiment, the inner circumference of the sub valve body 8 attached to the sub piston split body 5 is a fixed end which does not move relative to the sub piston split body 5. Furthermore, the outer circumference of the sub valve body 8 is a free end which moves up and down (both sides in the axial direction) relative to the sub piston split body 5 when the sub valve body 8 deflects. In a state where the inner periphery of the sub valve body 8 is fixed, the central leaf valve having the maximum outer diameter in the sub valve body 8 faces the opposing portion 5d provided on the inner periphery of the casing portion 5b in the sub piston split body 5 via an annular gap having an extremely short width.

In an extremely low-speed range where the piston speed is close to zero, or when the shock absorber D starts to work, the sub valve body 8 does not deflect, and the free end of the sub valve body 8 faces the opposing portion 5d across the annular gap. In this embodiment, the annular gap between the opposing portion 5d and the free end of the sub valve body 8 facing each other is very narrow, and a flow passage area in the annular gap is designed to be smaller than a flow passage area of all the orifices formed by the cutouts 6a and 7a in the main valve bodies 6 and 7.

In contrast, when the shock absorber D extends or contracts while the piston speed is in the low-speed range or in the medium- or high-speed range, the sub valve body 8 deflects upward or downward and increases the annular gap between the opposing portion 5d and the free end of the sub valve body 8 shifted upward or downward, thereby making the flow passage area in the annular gap larger than the flow passage area of the orifices formed by the cutouts 6a and 7a.

When the sub valve body 8 deflects upward or downward, an increase in deflection amount causes a radially intermediate portion of the sub valve body 8 to abut on and be supported by the stopper member 40 or stopper member 41. A further increase in deflection amount of the sub valve body 8 causes the middle leaf valve in the sub valve body 8 to abut on an outer circumferential edge of the stopper member 9 or nut 30, thereby preventing the sub valve body 8 from deflecting further.

In this manner, when the deflection of the sub valve body 8 is promoted, the middle leaf valve of the sub valve body 8 abuts on the stopper member 9 or nut 30 while the radially intermediate portion is supported by the stopper member 40 or stopper member 41, so that the sub valve body 8 is prevented from deflecting further. Accordingly, when the sub valve body 8 deflects to the maximum extent, the sub valve body 8 curves in such a manner that the inclination gradually increases toward the free end, which reduces stress around the deflection fulcrums of the sub valve body 8 and enhances the durability of the sub valve body 8.

Furthermore, in this embodiment, in the initial state where the sub valve body 8 is not deflected, the free end has a diameter larger than an outside diameter of the stopper member 9 and an outside diameter of a part of the nut 30 closer to the sub valve body 8. For this reason, when the sub valve body 8 abuts on the stopper member 9 or nut 30, a gap between the stopper member 9 or nut 30 and the opposing portion 5d becomes smaller than the annular gap between the free end of the sub valve body 8 and the opposing portion 5d and prevents the reduction of a liquid flow. Note that the sub valve body 8 may have any configuration as long as it includes at least one leaf valve and that the leaf valve on which each supporting portion abuts may be changed in an appropriate manner.

Hereinafter described is an operation of the shock absorber D provided with a damping valve (valve) V according to the present embodiment. When the shock absorber D extends, the piston 2 moves upward inside the cylinder 1 and compresses the extension side chamber L1, and a liquid in this extension side chamber L1 passes through the passage P and moves to the compression side chamber L2. With respect to a flow of the liquid, the extension side main valve body 6, the orifice formed by the cutout 6a or 7a of the main valve body 6 or 7, or the sub valve body 8 offers resistance to increase pressure of the extension side chamber L1, thereby enabling the shock absorber D to exert an extension side damping force that prevents extension operation.

In contrast, when the shock absorber D contracts, the piston 2 moves downward inside the cylinder 1 and compresses the compression side chamber L2, and a liquid in this compression side chamber L2 passes through the passage P and moves to the extension side chamber L1. With respect to a flow of the liquid, the compression side main valve body 7, the orifice formed by the cutout 6a or 7a of the main valve body 6 or 7, or the sub valve body 8 offers resistance to increase pressure of the compression side chamber L2, thereby enabling the shock absorber D to exert a compression side damping force that prevents contraction operation.

In this embodiment, the extension side and compression side main valve bodies 6 and 7 are opened according to the piston speed or the outer circumferential portion (free end side) of the sub valve body 8 deflects upward or downward to enable the shock absorber D to exert a speed-dependent damping force depending on the piston speed.

More specifically, when the piston speed is in the extremely low-speed range close to zero, the extension side and compression side main valve bodies 6 and 7 are closed, and the sub valve body 8 does not deflect and the free end faces the opposing portion 5d.

When the shock absorber D extends while the piston speed is in the extremely low-speed range, a liquid passes through the cutouts 6a and 7a of the extension side and compression side main valve bodies 6 and 7 and flows from the extension side chamber L1 to the tubular portion 4b, and flows downward through the communication passage 5c in FIG. 2, and then, flows in the compression side chamber L2 from the annular gap between the free end of the sub valve body 8 and the opposing portion 5d facing each other.

In contrast, when the shock absorber D contracts while the piston speed is in the extremely low-speed range, a liquid flows in the casing portion 5b from the compression side chamber L2 through the annular gap between the free end of the sub valve body 8 and the opposing portion 5d facing each other, and then, flows upward in FIG. 2 through the casing portion 5b and the communication passage 5c toward the extension side chamber L1 via the cutouts 6a and 7a of the extension side and compression side main valve bodies 6 and 7.

As described above, since the annular gap between the free end of the sub valve body 8 and the opposing portion 5d facing each other has a very small opening area, when the piston speed is in the extremely low-speed range, the shock absorber D exerts a damping force in the extremely low-speed range attributed to resistance when a liquid flows in the annular gap.

When the shock absorber D extends or contracts at an extremely low speed, an amount of liquid passing through the passage P is extremely small. In this state, when the seal ring 12 for sealing the gap between the main piston split body 4 and the sub piston split body 5 moves axially within the annular groove 50, an amount of liquid passing through the annular gap between the sub valve body 8 and the opposing portion 5d is reduced by a distance through which the seal ring 12 moves. In other words, the gap between the main piston split body 4 and the sub piston split body 5 is sealed by the seal ring 12, but the axial displacement of the seal ring 12 within the annular groove 50 produces an effect as in a condition where the liquid apparently passes through the gap between the main piston split body 4 and the sub piston split body 5. Reduction in amount of liquid passing through the annular gap causes reduction in rate of flow passing through the annular gap, which causes a time delay in generating a damping force of the shock absorber D. However, in the seal device S in the shock absorber D of the present embodiment, the seal ring 12 includes the cylindrical surface 13a centered on the axis A on the inner peripheral surface 13 serving as the bottom facing surface facing the bottom 51 of the annular groove 50, and the entire cylindrical surface 13a is in close contact with the bottom 51 over a wide area. Therefore, a large frictional force is generated between the seal ring and the bottom 51, and the seal ring cannot move in the axial direction with respect to the annular groove 50. In this manner, the inner circumference of the seal ring 12 is restrained and the axial displacement within the annular groove 50 is regulated. Accordingly, even though the seal ring 12 has a self-lubricating property and is subjected to surface treatment to create a reduced frictional force, the seal ring 12 does not move axially within the annular groove 50, thereby preventing a time delay in generating a damping force of the shock absorber D.

When the piston speed increases and gets in the low-speed range from the extremely low-speed range, the extension side and compression side main valve bodies 6 and 7 are closed, but the outer circumferential portion of the sub valve body 8 deflects downward at the time of extension and deflects upward at the time of contraction, which causes a vertical shift between the free end of the sub valve body 8 and the opposing portion 5d. The opening area of the annular gap between the free end and the opposing portion 5d becomes larger than an opening area of the orifices formed by the cutouts 6a and 7a.

Therefore, when the piston speed is in the low-speed range, the shock absorber D exerts a damping force in the low-speed range attributed to the resistance from the orifices formed by the cutouts 6a and 7a of the extension side and compression side main valve bodies 6 and 7. When the piston speed changes from the extremely low-speed range to the low-speed range, the damping coefficient of the shock absorber D decreases.

When the piston speed further increases and gets in the medium- or high-speed range from the low-speed range, the outer circumferential portion of the sub valve body 8 naturally deflects upward or downward, and the extension side main valve body 6 opens at the time of extension, and the compression side main valve body 7 opens at the time of contraction.

In this embodiment, when the extension side main valve body 6 is opened, an outer circumferential portion of the main valve body 6 deflects downward, which allows a liquid to pass through a gap between the outer circumferential portion and the main piston split body 4. Similarly, when the compression side main valve body 7 is opened, an outer circumferential portion of the main valve body 7 deflects upward, which allows a liquid to pass through a gap between the outer circumferential portion and the main piston split body 4.

Therefore, when the piston speed is in the medium- or high-speed range, the shock absorber D exerts a damping force in the medium- or high-speed range attributed to resistance from the gap caused by opening the extension side main valve body 6 or the compression side main valve body 7. When the piston speed changes from the low-speed range to the medium- or high-speed range, the damping coefficient of the shock absorber D decreases.

Partway in the medium- or high-speed range, the deflection amount of the extension side and compression side main valve bodies 6 and 7 may be regulated. In this case, the damping coefficient increases again at a speed at which the deflection amount of the extension side and compression side main valve bodies 6 and 7 reach a maximum.

As described above, a seal device S for a hydraulic apparatus in the present embodiment includes an annular main piston split body (outer member) 4, a sub piston split body (inner member) 5 inserted into inside the main piston split body (outer member) 4, and a seal ring 12 accommodated in an annular groove 50 provided in the outer circumference of the sub piston split body (inner member) 5 and abutting on the main piston split body (outer member) 4 to prevent a liquid from passing through a gap between the main piston split body (outer member) 4 and the sub piston split body (inner member) 5, in which the seal ring 12 has a self-lubricating property and has a cylindrical surface 13a centered on an axis A on an inner peripheral surface (bottom facing surface) 13 facing a bottom 51 of the annular groove 50.

The seal ring 12 herein is designed to have a diameter enlarged when accommodated in the annular groove 50. In order to place the seal ring 12 in the annular groove 50, the seal ring 12 is required to be enlarged in diameter to be fitted into the outer circumference of the fitting portion 5a while being able to slide on the circumferential surface of the fitting portion 5a, and the seal ring 12 tightening the outer circumference of the fitting portion 5a is subjected to frictional resistance created between the seal ring 12 and the sub piston split body (inner member) 5. Furthermore, the seal ring 12 placed in the annular groove 50 of the sub piston split body (inner member) 5 has the outer circumference protruding from the fitting portion 5a when viewed from the axial direction and has an outside diameter larger than an inside diameter of the tubular portion 4b of the main piston split body (outer member) 4. Accordingly, when the sub piston split body (inner member) 5 with the seal ring 12 placed therein is fitted into the tubular portion 4b of the main piston split body (outer member) 4, the seal ring 12 is strongly pressed against the tubular portion 4b, and the seal ring 12 is subjected to frictional resistance created between the seal ring 12 and the tubular portion 4b. In this manner, when the seal ring 12 is placed in the annular groove 50 of the sub piston split body (inner member) 5 and the sub piston split body (inner member) 5 is fitted into the main piston split body (outer member) 4, the seal ring 12 is subjected to frictional resistance. However, in the seal device S according to this embodiment, the seal ring 12 has a self-lubricating property and reduces a frictional force, so that the resistance is reduced when the seal ring 12 is placed in the annular groove 50 of the sub piston split body (inner member) 5 and the sub piston split body (inner member) 5 is fitted into the main piston split body (outer member) 4. Accordingly, the seal device S of this embodiment facilitates the operation of placing the seal ring 12 in the annular groove 50 disposed in the outer circumference of the fitting portion 5a of the sub piston split body (inner member) and also facilitates the operation of fitting the sub piston split body (inner member) 5 with the seal ring 12 placed therein into the tubular portion 4b of the main piston split body (outer member) 4. In order to further enhance ease in fitting the sub piston split body (inner member) 5 into the main piston split body (outer member) 4, the seal ring 12 having self-lubricating properties may be subjected to surface treatment to have a smooth surface.

Further, in the seal device S of the present embodiment, since the cylindrical surface 13a is provided on the inner peripheral surface (bottom facing surface) 13 of the seal ring 12, even if the seal ring 12 has a self-lubricating property, a large frictional force can be generated between the seal ring 12 and the bottom 51 of the annular groove 50 to regulate the axial movement of the seal ring 12 in the annular groove 50.

Therefore, according to the seal device S of the present embodiment, it is possible to prevent occurrence of a phenomenon in which liquid apparently passes between the main piston split body (outer member) 4 and the sub piston split body (inner member) 5 due to the movement of the seal ring 12 in the annular groove 50. That is, the seal device S can regulate the axial movement of the seal ring 12 in the annular groove 50 while improving the assemblability of the seal ring 12 to the main piston split body 4 and the sub piston split body 5 by providing the seal ring 12 has a self-lubricating property to reduce the frictional force. Therefore, according to the seal device S of this embodiment, it is possible to enhance ease of assembly while preventing a time delay in generating a damping force in the shock absorber D to which the seal device S is applied.

Even if the cylindrical surface 13a is formed on a part of the inner peripheral surface 13 facing the bottom 51 of the annular groove 50 of the seal ring 12, the contact area between the seal ring 12 and the bottom 51 can be increased, so that the effect of the present invention can be achieved. However, the entire inner peripheral surface (bottom facing surface) 13 of the seal ring 12 may be the cylindrical surface 13a centered on the axis A.

Furthermore, since the axial movement of the seal ring 12 can be restricted, the seal device S may not be in contact with the seal ring 12 in a state where the seal device S is assembled, where the width of the side walls 52 and 52 of the annular groove 50 is longer than the axial width of the seal ring 12. However, it is preferable that the side walls 52 and 52 should be in contact with the seal ring 12 after the seal device S is assembled and that the side walls 52 and 52 should also regulate the displacement of the seal ring 12. Furthermore, in the seal device S according to this embodiment, the side walls 52 and 52 face each other in parallel but may be designed to face each other in other conditions.

In addition, the seal ring 12 in the seal device S of the present embodiment includes curved surfaces 13b and 13b that move away from the bottom of the annular groove 50 toward the axial end on both sides in the axial direction of the cylindrical surface 13a provided on the inner peripheral surface (bottom facing surface) 13. In the seal device S configured as described above, even if the seal ring 12 is twisted and mounted in the annular groove 50 when the seal ring 12 is placed in the annular groove 50, the curved surfaces 13b and 13b are formed so that there is no angle having an acute angle in the cross section on both sides in the axial direction of the inner peripheral surface 13, so that the twisting of the seal ring 12 can be easily eliminated and the assemblability can be improved. In addition, since the cylindrical surface 13a is provided on the inner peripheral surface (bottom facing surface) 13 with respect to the seal ring 12, the volume is larger than that of the seal ring having a circular cross section, and thus, the filling rate, which is the ratio of the volume of the seal ring 12 to the volume in the annular groove 50, is large. When the filling rate increases, the amount of the seal ring 12 protruding from the annular groove 50 also increases, and the seal ring 12 may be worn when the sub piston split body 5 in which the seal ring 12 is placed is fitted to the main piston split body 4. If debris is generated due to wear of the seal ring 12 and left in the shock absorber D, the damping performance generated by the shock absorber D may be adversely affected. On the other hand, in the seal device S of the present embodiment, even if the cylindrical surface 13a is provided on the inner peripheral surface (bottom facing surface) 13 with respect to the seal ring 12, since the curved surfaces 13b and 13b are provided on both sides in the axial direction of the cylindrical surface 13a, it is possible to prevent the filling rate from becoming too large, so that wear of the seal ring 12 can be suppressed, and the shock absorber D can exhibit stable damping performance. As described above, when the filling rate of the seal ring 12 with respect to the annular groove 50 is set to 80% or more and 90% or less, the seal ring 12 hardly moves in the annular groove 50, so that it is possible to further effectively suppress the positional deviation of the seal ring 12 in the axial direction.

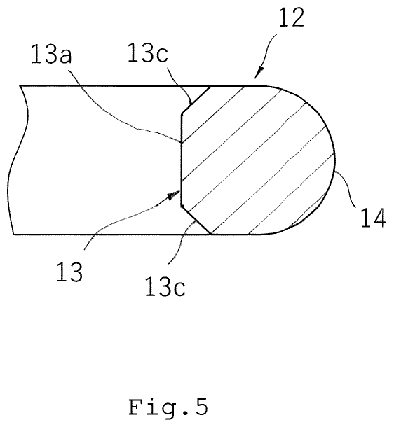

As illustrated in FIG. 5, even if the tapered surfaces 13c and 13c are provided instead of the curved surfaces 13b and 13b on both sides in the axial direction of the cylindrical surface 13a of the inner peripheral surface (bottom facing surface) 13 of the seal ring 12, similarly, an angle having an acute angle in the cross section is not formed on both sides in the axial direction of the cylindrical surface 13a, so that advantages such as improvement in assemblability of the seal ring 12 and suppression of wear can be obtained. From the viewpoint of preventing the filling rate from becoming too large, the curved surface 13b or the tapered surface 13c may be provided only on the axial side of the cylindrical surface 13a of the inner peripheral surface (bottom facing surface) 13 of the seal ring 12.

In the seal device S of the present embodiment, the bottom 51 of the annular groove 50 includes a cylindrical bottom surface 51a having the deepest groove depth at the center, and curved surfaces 51b and 51b that are vertically continuous on both axial sides of the bottom surface 51a and gradually decrease in depth toward the side wall 52. In the seal device S configured as described above, in a case where the seal ring 12 includes the curved surfaces 13b and 13b on both axial sides of the cylindrical surface 13a of the inner peripheral surface 13, when the seal ring 12 is accommodated in the annular groove 50, not only the cylindrical surface 13a comes into close contact with the bottom surface 51a, but also the curved surface 13b and the curved surface 51b come into close contact with each other. Therefore, the inner peripheral surface 13 of the seal ring 12 is restrained by the bottom 51, and the positional deviation of the seal ring 12 in the axial direction can be further effectively suppressed.

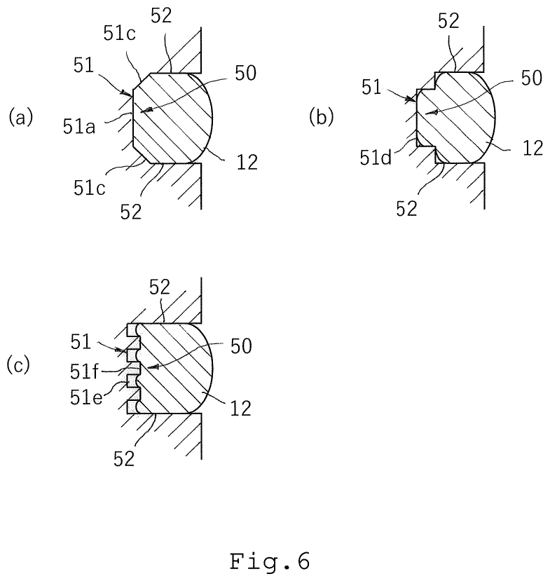

In addition, the bottom 51 of the annular groove 50 may include, for example, as illustrated in FIG. 6(a), the cylindrical bottom surface 51a having the deepest groove depth at the center in FIG. 6, and the tapered surfaces 51c and 51c that are vertically continuous with the cylindrical bottom surface 51a and gradually decrease in depth toward the side wall 52 to form a recess as a whole, in addition to the shape described above. Furthermore, as illustrated in FIG. 6(b), the bottom 51 of the annular groove 50 may include the cylindrical bottom surface 51d formed by digging down the center in the vertical direction in FIG. 6 one step to increase the groove depth. Even if the bottom surface 51d of the bottom 51 is formed in this manner, the cylindrical surface 13a of the inner peripheral surface (bottom facing surface) 13 of the seal ring 12 comes into close contact with the bottom surface 51d to generate a frictional force, so that it is possible to regulate the axial movement of the seal ring 12 in the annular groove 50. As described above, when a deep bottom surface 51d is provided on which the cylindrical surface 13a comes into contact and the bottom 51 is made concave, since corner portions that engage the inner peripheral surface 13 of the seal ring 12 are formed on both sides of the bottom surface 51d in the axial direction, the restraint force of the seal ring 12 can be increased to more effectively restrict the movement in the axial direction with respect to the annular groove 50.

Furthermore, as illustrated in FIG. 6(c), the bottom 51 of the annular groove 50 may have a shape in which irregularities consisting of a recess 51e and a protrusion 51f are continuous in the axial direction. When the bottom 51 has a shape having irregularities as described above, the protrusion 51f and the cylindrical surface 13a of the seal ring 12 are brought into close contact with each other to generate a frictional force, and the inner peripheral surface 13 of the seal ring 12 is fitted and restrained in the irregularities of the bottom 51 formed in the bottom 51, so that the axial movement of the seal ring 12 in the annular groove 50 can be more effectively restricted. The recess and protrusion may be partially disposed in the bottom 51 in the axial direction, or up-down direction in FIG. 6(c), as long as the recess and protrusion can regulate the axial displacement of the seal ring 12 within the annular groove 50.

The shock absorber D according to this embodiment includes the cylinder 1, the piston 2 inserted into the cylinder 1 to be axially movable and including the passage P configured to partition the interior of the cylinder 1 into the extension side chamber L1 and the compression side chamber L2 and to communicate the extension side chamber L1 and the compression side chamber L2, the rod 3 inserted into the cylinder 1 to be axially movable and connected to the piston 2, the valve V configured to open and close the passage P, and the seal device S. The piston 2 includes the main piston split body (outer member) and the sub piston split body (inner member) 5. According to the shock absorber D with this configuration, at the time of extension or contraction at an extremely low speed, the seal device S prevents a phenomenon of a liquid apparently bypassing the valve V in the passage P and passing through the gap between the main piston split body (outer member) and the sub piston split body (inner member) 5. Accordingly, without reducing a rate of flow passing through the valve V, the shock absorber D of this embodiment enables creation of a damping force as designed from the beginning of operation and prevents a time delay in generating a damping force.

In the above description, the annular groove 50 is disposed in the sub piston split body 5 as the inner member, and the seal ring 12 is placed in the sub piston split body 5. However, an annular groove for housing the seal ring 12 may be disposed in a part of the main piston split body 4 as the outer member which fits into the sub piston split body 5.

Further, in the present embodiment, as illustrated in FIG. 3 or 6, the bottom 51 of the annular groove 50 has a shape having the curved surfaces 51b and 51b, the tapered surfaces 51c and 51c, and further the unevenness in addition to the cylindrical bottom surface 51a, but may have a shape having only the cylindrical bottom surface 51a as a whole. That is, the shape of the bottom 51 of the annular groove 50 only needs to include a surface on which at least the cylindrical surface 13a of the seal ring 12 comes into close contact in a facing manner to generate a frictional force that restricts the axial movement of the seal ring 12.

In a case where the seal ring 12 is placed in the annular groove of the outer member, since the bottom facing surface facing the bottom of the annular groove of the seal ring 12 is the outer peripheral surface, a cylindrical surface centered on the axis may be provided on at least a part of the outer peripheral surface of the seal ring 12, and the cylindrical surface may be provided in close contact with the bottom of the annular groove in a facing manner to generate a frictional force that restricts the axial movement of the seal ring 12.

In addition, in the shock absorber D according to this embodiment, an annular groove 11a is disposed in the outer circumference of the free piston 11, and the annular groove 11a houses a seal ring 60 slidably in contact with the inner circumference of the cylinder 1. The seal device S for a hydraulic apparatus may also be used to seal a gap between the cylinder 1 as an outer member and the free piston 11 as an inner member. Specifically, in the shock absorber D illustrated in FIG. 1, the inner peripheral surface of the seal ring 60 is curved surfaces 60b and 60b continuous with both axial sides of cylindrical surface 60a and the cylindrical surface 60a, similarly to the seal ring 12 illustrated in FIG. 4. The cylindrical surface of the seal ring 60 is brought into close contact with the cylindrical bottom 11b of the annular groove 11a of the free piston 11 to regulate the axial movement of the seal ring 60. When the shock absorber D extends or contracts at an extremely low speed and the seal ring 60 moves axially relative to the free piston 11 within the annular groove 11a, an amount of liquid passing to and from the extension side chamber L1 and the compression side chamber L2 is reduced, which causes a time delay in generating a damping force at the beginning of extension or contraction. However, in the shock absorber D according to this embodiment, since the axial displacement of the seal ring 60 within the annular groove 11a is regulated, it is possible to eliminate a time delay in generating a damping force in this shock absorber D.

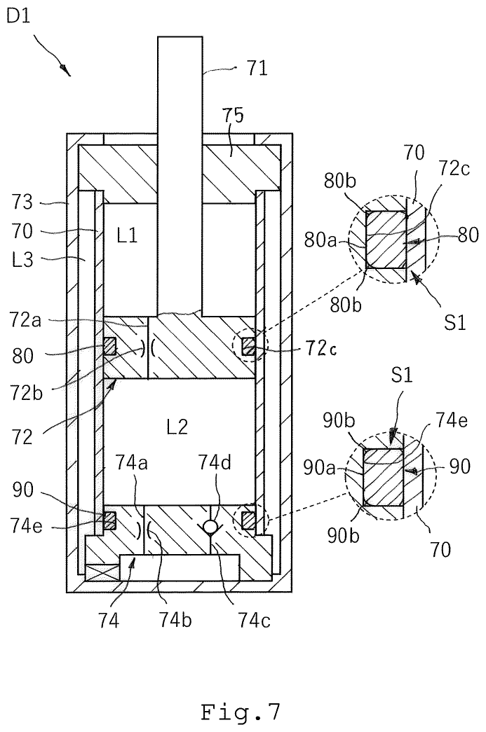

Alternatively, as illustrated in FIG. 7, a shock absorber D1 may include a cylinder 70, a rod 71 inserted into the cylinder 70 to be axially movable, a piston 72 as a partition wall inserted into the cylinder 70, and a seal device S1. The piston 72 includes a passage 72a which partitions the interior of the cylinder 70 into two operation chambers, that is, an extension side chamber L1 and a compression side chamber L2, and communicates the extension side chamber L1 and the compression side chamber L2. The seal device S1 includes a seal ring 80 that is accommodated in an annular groove 72c having a rectangular cross-sectional shape provided on the outer periphery of the piston 72 and is in close contact with the inner periphery of the cylinder 70, with the cylinder 70 as an outer member and the piston 72 as an inner member. The piston 72 includes the passage 72a communicating the extension side chamber L1 and the compression side chamber L2 and a valve 72b disposed in the passage 72a and configured to offer resistance to a flow of a liquid passing through the passage 72a. Similarly to the seal ring 12 illustrated in FIG. 4, the seal ring 80 includes a cylindrical surface 80a on the inner peripheral surface and curved surfaces 80b and 80b continuous with both axial sides of the cylindrical surface 80a.

The shock absorber D1 also includes an outer shell 73 which covers the outer circumference of the cylinder 70 and forms a reservoir L3 filled with a liquid and gas between the outer shell 73 and the cylinder 70. The cylinder 70, the rod 71, the piston 72, and the outer shell 73 constitute a shock absorber main body.

A lower end of the cylinder 70 is provided with a valve case 74 which separates the compression side chamber L2 and the reservoir L3 inside the shock absorber main body. The valve case 74 includes a passage 74a communicating the compression side chamber L2 and the reservoir L3, a valve 74b disposed in the passage 74a, and a suction passage 74c provided with a check valve 74d which allows a unidirectional flow of a liquid from the reservoir L3 to the compression side chamber L2. An annular rod guide 75 around the rod 71 is attached to the upper ends of the cylinder 70 and the outer shell 73, and the opening portions of the upper ends of the cylinder 70 and the outer shell 73 are closed by the rod guide 75. As described above, the shock absorber D1 is what is called a twin-tube shock absorber including the reservoir L3 between the cylinder 70 and the outer shell 73 disposed in the outer circumference of the cylinder 70.

In the shock absorber D1 in the present embodiment, the seal ring 80 having the cylindrical surface 80a on the inner peripheral surface is placed in the annular groove 72c of the piston 72 to regulate the axial movement of the seal ring 80. When the shock absorber D1 extends or contracts at an extremely low speed and the seal ring 80 moves axially relative to the piston 72 within the annular groove 72c, an amount of liquid passing to and from the extension side chamber L1 and the compression side chamber L2 through the valve 72b of the passage 72a is reduced, which causes a time delay in generating a damping force at the beginning of extension or contraction. However, in the shock absorber D1 according to this embodiment, since the axial displacement of the seal ring 80 within the annular groove 72c is regulated, it is possible to eliminate a time delay in generating a damping force in this shock absorber D1.

In the shock absorber D1, an annular groove 74e having a rectangular cross-sectional shape is provided on the outer periphery of the valve case 74, and a seal ring 90 slidably in contact with the inner periphery of the cylinder 70 is accommodated in the annular groove 74e. Similarly to the seal ring 12 illustrated in FIG. 4, the seal ring 90 includes a cylindrical surface 90a on the inner peripheral surface and curved surfaces 90b and 90b continuous with both axial sides of the cylindrical surface 90a. As described above, the seal device S1 for a hydraulic apparatus may also be used to seal a gap between the cylinder 70 as an outer member and the valve case 74 as inner member. Specifically, in the shock absorber D1 illustrated in FIG. 7, the seal ring 90 having the cylindrical surface 90a on the inner periphery is placed in the annular groove 74e of the valve case 74 to regulate the axial movement of the seal ring 90. When the shock absorber D1 contracts at an extremely low speed and the seal ring 90 moves axially relative to the valve case 74 within the annular groove 74e, an amount of liquid passing from the compression side chamber L2 to the reservoir L3 through the valve 74b of the passage 74a is reduced, which causes a time delay in generating a damping force when the shock absorber D1 starts to contract. However, in the shock absorber D1 according to this embodiment, since the axial displacement of the seal ring 90 within the annular groove 74e is regulated, it is possible to eliminate a time delay in generating a damping force in this shock absorber D1. In this manner, the seal device S1 may also be employed in the twin-tube shock absorber D1 and enables elimination of a time delay in generating a damping force of the shock absorber D1.

The seal devices S and S1 are applicable to any part within the shock absorbers D and D1 where pressure of a liquid or gas acts on a seal ring. For example, in a case where a seal ring is accommodated in an annular groove disposed in the inner circumference of the rod guide 10 and used to seal a gap between the rod guide 10 as an outer member and the rod 3 as an inner member, the seal device S is applicable for this sealing. The seal devices S and S1 are applicable to not only the shock absorbers D and D1 but also other hydraulic apparatus such as a cylinder device configured to extend and contract by supplying a liquid to and discharging the liquid from a cylinder. In a case where the seal device S or S1 is applied to a cylinder device, it is possible to prevent apparent reduction in amount of liquid due to axial displacement of a seal ring, thereby eliminating a time delay in generating thrust at the beginning of extension or contraction.

Note that the valves 72b and 74b may be of any type as long as they offer resistance to a flow of a liquid passing through the passages 72a and 74a and may be throttles such as orifices and chokes or may be leaf valves or other types of valves.

Although the preferred embodiment of the present invention has been described above in detail, modifications, variations, and changes can be made thereto without departing from the claims.

### REFERENCE SIGNS LIST

1 Cylinder
2 Piston
3 Rod
4 Main piston split body (outer member)
5 Sub piston split body (inner member)
11a, 50, 72c, 74e Annular groove
12, 60, 80, 90 Seal ring
13 Inner peripheral surface (bottom facing surface)
13a, 60a, 80a, 90a Cylindrical surface
13b, 60b Curved surface
13c Tapered surface
11b, 51 Bottom (recess)
72 Piston (partition wall)
72a, 74a, P Passage
72b, 74b, V Valve
D, D1 Shock absorber (hydraulic apparatus)
L1 Extension side chamber (operation chamber)
L2 Compression side chamber (operation chamber)
L3 Reservoir (operation chamber)
S, S1 Seal device

1. A seal device for a hydraulic apparatus, comprising:
an outer member having an annular shape;
an inner member inserted into the outer member; and
a seal ring accommodated in an annular groove disposed in one of the outer member and the inner member and abutting on the other of the outer member and the inner member to prevent a liquid from passing through a gap between the outer member and the inner member, wherein
the seal ring has a self-lubricating property, has a cylindrical surface centered on h axis on a bottom facing surface facing the bottom of the annular groove, and brings the cylindrical surface into close contact with the bottom of the annular groove by a self-restoring force.

2. The seal device for a hydraulic apparatus according to claim 1, wherein
the seal ring has a tapered surface or a curved surface on both sides in an axial direction of a cylindrical surface provided on the bottom facing surface, the tapered surface or the curved surface being away from a bottom of the annular groove toward an axial end.

3. A shock absorber comprising:
a cylinder;
a rod inserted into the cylinder to be axially movable;
a partition wall inserted into the cylinder, configured to partition an interior of the cylinder into two hydraulic chambers, and including a passage communicating the hydraulic chambers; and
the seal device for a hydraulic apparatus according to claim 1,
the outer member being the cylinder, and
the inner member including the partition wall and a valve configured to open and close the passage.

4. A shock absorber comprising:
a cylinder;
a piston inserted into the cylinder to be axially movable, configured to partition the interior of the cylinder into an extension side chamber and a compression side chamber, and including a passage communicating the extension side chamber and the compression side chamber;
a rod inserted into the cylinder to be axially movable and connected to the piston;
a valve configured to open and close the passage; and
the seal device for a hydraulic apparatus according to claim 1,
the piston including the outer member and the inner member.

5. The seal device for a hydraulic apparatus according to claim 1, wherein
a filling rate of the seal ring with respect to the annular groove is set to 80% or more and 90% or less.

6. The shock absorber according to claim 4, wherein
the valve includes a main valve body and a sub valve body provided in series in the passage,
the main valve body generates a damping force when a piston speed is in a medium- or high-speed range,
the sub valve body generates a damping force when a piston speed is in an extremely low-speed range, and
the piston includes one of the outer member and the inner member to which the main valve body is attached, and the other of the outer member and the inner member to which the sub valve body is attached.
